(19) United States
(12) Patent Application Publication
(10) Pub. No.: US 2008/0043681 A1
(43) Pub. Date: Feb. 21, 2008

(54) Gap and preamble parameters for control channel transmission

(75) Inventors: Anna-Mari Vimpari, Oulu (FI); Karri Ranta-Aho, Espoo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/827,447

(22) Filed: Jul. 11, 2007

Related U.S. Application Data
(60) Provisional application No. 60/839,175, filed on Aug. 21, 2006.

(51) Int. Cl. H04B 7/216

(52) U.S. Cl. 370/335

(57) ABSTRACT

The specification and drawings present a new method, system, apparatus and software product for defining parameters for a control signal (e.g., discontinuous signal) for an uplink control channel using a predetermined criterion depending on a maximum allowed data rate and/or an actual data rate of a data signal on an uplink data channel. The parameters can comprise at least one of: a preamble length of a preamble of the control signal, a gap length of inactive transmission period, and/or a burst length of an active transmission period of the control signal. The uplink control channel can be an uplink dedicated physical control channel (DPCCH) and the data channel can be an enhanced dedicated channel (E-DCH).

### PRIORITY AND CROSS-REFERENCE TO RELATED APPLICATION

This application claims priority from U.S. patent application Ser. No. 60/839,175, filed on Aug. 21, 2006.

### TECHNICAL FIELD

This invention generally relates to communications, e.g., wireless communications, and more specifically to defining parameters for an uplink control channel transmission.

### BACKGROUND ART

In an uplink (a direction from a user equipment to a network), when no dedicated channels (DCHs) and no corresponding dedicated physical data channels (DPDCHs) are configured, all data is transmitted on an enhanced dedicated channel (E-DCH) which is mapped to an enhanced dedicated physical data channel (E-DPDCH). Control signaling associated with the E-DCH is transmitted on an enhanced dedicated physical control channel (E-DPCCH). The E-DPDCH and E-DPCCH can be discontinuous and are transmitted only when there is data to be transmitted and the transmission has been granted by the network. In the uplink, in addition to the E-DPDCH and E-DPCCH, a continuous dedicated physical control channel (DPCCH) and possibly a continuous or discontinuous dedicated physical control channel (e.g., an uplink high speed dedicated physical control channel, HS-DPCCH) for an HS-DSCH (high speed downlink shared channel) are transmitted.

A packet service session contains one or several packet calls depending on the application as described in ETSI standard, TR 101 112, UMTS 30.03 “Selection procedures for the choice of radio transmission technologies of the UMTS”. The packet service session can be considered as an NRT (non-real time) radio access bearer duration and the packet call as an active period of packet data transmission. During the packet call several packets may be generated, which means that the packet call constitutes a bursty sequence of packets. The burstiness is a characteristic feature of the packet transmission.

The arrival of session set-ups to the network can be modeled as a Poisson process. Reading time starts when the last packet of the packet call is completely received by the user and ends when the user makes a request for the next packet call. The E-DCH transmission in the uplink is discontinuous during a reading time, such that during most of the reading time there is no E-DCH transmission. Note, that depending on the packet arrival intervals (among other things), there could be gaps in the E-DCH) transmission during a packet call but the E-DCH transmission might also be continuous during the packet call. Thus, there can be some inactivity on the E-DCH also during a packet call.

In a UL direction from a user equipment (UE) to a network, also a signal on a high speed dedicated physical control channel (HS-DPCCH) can be transmitted. The HS-DPCCH signal typically carries 2 slots with channel quality indicator (CQI) reporting information and 1 slot with ACK/NACK information for the HSDPA. CQI transmission is typically periodic and normally independent of the HS-DSCH transmission activity. CQI reporting period can be controlled by a radio network controller (RNC) with possible values of 0, 2, 4, 8, 10, 20, 40, 80, and 160 ms. ACK/NACK is transmitted only as a response to a packet transmission on the HS-DSCH, which (similar to the E-DCH) is transmitted only when there is data to be transmitted and which depends on the reading time and packet arrival times during the packet call.

For the E-DCH transmission, a grant is needed: a non-scheduled grant for non-scheduled MAC-d (MAC stands for medium access control) flows and a serving grant (and allowed active hybrid automatic repeat request (HARQ) process) for a scheduled transmission. In the case of the scheduled MAC-d flows, a Node B controls when a user equipment (UE) is allowed to send and thus Node B knows when the UE may send data. For the non-scheduled MAC-d flows, the network can allow a maximum number of bits that can be included in a MAC-e PDU (protocol data unit) for the given MAC-d flows. In case of 2 ms E-DCH TTI (transmission timing interval), each non-scheduled grant is applicable for a specific set of HARQ processes indicated by an RRC (radio resource control), and RRC can also restrict the set of HARQ processes for which scheduled grants are applicable. Also there must be a sufficient transmit power available in the UE to transmit the intended number of bits with the power level needed for intended reliability of the transmission, except for a minimum set (defined by the network), which defines a number of bits that can be transmitted on the E-DCH in the TTI also when there is not enough transmit power to maintain the intended reliability. (This minimum set for the E-DCH may only exist if there is no DCH configured for the connection.)

As described in 3GPP standard TS25.133 “Medium Access Control (MAC) Protocol Specification”, when the UE estimates that a certain E-TFC (E-DCH transport format combination) would require more power than the maximum transmit power, it limits the usage of E-DCH transport format combinations for the assigned E-DCH transport format set. E-TFC selection is based on the estimated power leftover from TFC (transport format combination) selection if the DPDCH is present and from the HS-DPCCH. The UE can update the remaining power estimate of each E-TFC at least every E-DCH TTI. The UE will use the latest available remaining power estimate at the time when all absolute and relative grants relating to the E-DCH TTI under consideration have been received. Using the estimates, the UE can evaluate for each E-TFC which configured MAC-d flows are supported and which are unsupported.

The UL DPCCH carries control information generated at layer 1 (physical layer). The layer 1 control information consists of, e.g., known pilot bits to support channel estimation for coherent detection, transmit power control (TPC) for DL DPCH (dedicated physical channel), optional feedback information (FBI) and optional transport format combination indicator (TFCI). Typically, the UL DPCCH is continuously transmitted (even if there is no data to be transmitted for certain time periods), and there is one UL DPCCH for each radio link. The continuous transmission is not a problem with circuit switched services, which are typically sent continuously. However, for bursty packet services, continuous DPCCH transmission causes a significant overhead.

The uplink capacity can be increased by decreasing a control overhead. One possibility for decreasing the control overhead is UL DPCCH gating (or discontinuous transmission, DTX), i.e., not transmitting signals on the DPCCH all the time.

Rationale for using gating (DTX) includes (but is not limited to):
providing user equipment (UE) power savings and longer battery life;
providing interference reduction; and
providing higher capacity.

The uplink DPCCH behavior has the following stages with the uplink DPCCH DTX (gating) feature:
1. A gap during which no signal (not even the DPCCH) is transmitted with reduced UE power consumption and no interference;
2. An optional power control preamble (DPCCH-only transmission) transmitted after the gap to help the power control loop to converge before the actual E-DCH (or HS-DPCCH) transmission starts/continues after the transmission gap;
3. A transmission phase, when the DPCCH is transmitted with E-DCH (E-DPCCH+E-DPDCH) and/or HS-DPCCH transmission; and
4. A known DPCCH transmission that interrupts the gap occasionally even if there is no need to transmit E-DCH or HS-DPCCH; this is used to maintain an uplink synchronization and a rough uplink power control level.

The optimal setting of the gap length, the power control preamble length and the DPCCH burst length (phases 1, 2 and 4 above) depends on many factors and usually is a compromise. The problem is how to identify and control the parameterization of the discontinuous uplink DPCCH transmission (DTX, gating) feature and if possible make it to some extent adaptive so that in different operating conditions different parameter settings could be taken in use automatically.

### DISCLOSURE OF THE INVENTION

According to a first aspect of the invention, a method, comprises: defining at least one parameter of a control signal for an uplink control channel using a predetermined criterion, the at least one parameter being dependent on at least one of: a maximum allowed data rate of a data signal on an uplink data channel, and an actual data rate of the data signal; and transmitting the control signal with the at least one parameter on the uplink control channel by a user equipment to a network element.

According further to the first aspect of the invention, the control signal may be discontinuous and the at least one parameter may comprise at least one of: a preamble length of a preamble of the control signal, a gap length of an inactive transmission period, and a burst length of an active transmission period.

According further to the first aspect of the invention, a dependence of the at least one parameter on the maximum allowed data rate or on the actual data rate according to the predetermined criterion may be provided by the network element or provided in a specification.

Still further according to the first aspect of the invention, there may be at least one threshold value for the maximum allowed data rate or for the actual data rate below which the at least one parameter, defined according to the predetermined criterion, has a first value and above which the at least one parameter has a second value.

According further to the first aspect of the invention, the network element may be a Node B and the network element and the user equipment may be configured for wireless communications.

According still further to the first aspect of the invention, the maximum allowed data rate may be provided by the network element.

According further still to the first aspect of the invention, the uplink control channel may be an uplink dedicated physical control channel and the data channel may be an enhanced dedicated channel. Further, the maximum allowed data rate for the uplink dedicated physical control channel may be determined by the user equipment using one of: a maximum allowed relative power for an uplink dedicated physical control channel, the allowed relative power being provided by the network element to the user equipment, and a maximum number of bits for a MAC-e protocol data unit for a given MAC-d flow.

According yet further still to the first aspect of the invention, the defining may be provided by the user equipment.

According to a second aspect of the invention, a computer program product comprises: a computer readable storage structure embodying computer program code thereon for execution by a computer processor with the computer program code, wherein the computer program code comprises instructions for performing the first aspect of the invention, indicated as being performed by a component or a combination of components of a user equipment or a network element.

According to a third aspect of the invention, a user equipment, comprises: an uplink scheduling and signal generating module, configured to define at least one parameter of a control signal for an uplink control channel using a predetermined criterion, the at least one parameter being dependent on at least one of: a maximum allowed data rate of a data signal on an uplink data channel, and an actual data rate of the data signal; and a receiving/transmitting/processing module, configured to transmit the control signal with the at least one parameter on the uplink control channel to a network element.

Further according to the third aspect of the invention, the control signal may be discontinuous and the at least one parameter may comprise at least one of: a preamble length of a preamble of the control signal, a gap length of an inactive transmission period, and a burst length of an active transmission period.

Still further according to the third aspect of the invention, a dependence of the at least one parameter on the maximum allowed data rate or on the actual data rate according to the predetermined criterion may be provided by the network element or provided in a specification.

According further to the third aspect of the invention, there may be at least one threshold value for the maximum allowed data rate or for the actual data rate below which the at least one parameter, defined according to the predetermined criterion, may have a first value and above which the at least one parameter has a second value.

According still further to the third aspect of the invention, the maximum allowed data rate may be provided to the user equipment by the network element.

According yet further still to the third aspect of the invention, the uplink control channel may be an uplink dedicated physical control channel and the data channel may be an enhanced dedicated channel. Further, the uplink scheduling and signal generating module may be configured to determine the maximum allowed data rate for the uplink dedicated physical control channel using one of: a maximum allowed relative power for an uplink dedicated physical control channel, the allowed relative power being provided by the network element to the user equipment, and a maximum number of bits for a MAC-e protocol data unit for a given MAC-d flow.

According further still to the third aspect of the invention, an integrated circuit may comprise the uplink scheduling and signal generating module and the receiving/transmitting/processing module.

According to a fourth aspect of the invention, a user equipment, comprises: means for defining at least one parameter of a control signal for an uplink control channel using a predetermined criterion, the at least one parameter being dependent on at least one of: a maximum allowed data rate of a data signal on an uplink data channel, and an actual data rate of the data signal; and means for transmitting the control signal with the at least one parameter on the uplink control channel to a network element.

According further to the fourth aspect of the invention, the control signal may be discontinuous and the at least one parameter may comprise at least one of: a preamble length of a preamble of the control signal, a gap length of and inactive transmission period, and a burst length of an active transmission period.

According to a fifth aspect of the invention, a network element, comprises: an uplink planning and scheduling module, configured to provide at least one of: a maximum allowed data rate of a data signal on an uplink data channel, a maximum allowed relative power for an uplink dedicated physical control channel, and a maximum number of bits for a MAC-e protocol data unit for a given MAC-d flow, which are for defining at least one parameter of a control signal for an uplink control channel using a predetermined criterion; and a receiver, configured to receive the control signal with the at least one parameter transmitted by a user equipment on the uplink control channel.

According further to the fifth aspect of the invention, the defining of the at least one parameter may be performed by the user equipment or by the network element.

Further according to the fifth aspect of the invention, the control signal may be discontinuous and the at least one parameter may comprise at least one of: a preamble length of a preamble of the control signal, a gap length of inactive transmission period, and a burst length of an active transmission period.

According to a sixth aspect of the invention, a communication system, comprises: a user equipment, configured to provide a data signal on an uplink data channel and a control signal on an uplink control channel, wherein at least one parameter of the control signal may be defined by a predetermined criterion using at least one of: a maximum allowed data rate of a data signal on an uplink data channel, and an actual data rate of the data signal; control channel; and a network element, configured to receive the control signal with the at least one parameter.

According further to the sixth aspect of the invention, the network element may be a Node B and the network element and the user equipment may be configured for wireless communications.

According further to the sixth aspect of the invention, the defining may be provided by the network element or by the user equipment.

Still further according to the sixth aspect of the invention, the control signal may be discontinuous and the at least one parameter may comprise at least one of: a preamble length of a preamble of the control signal, a gap length of inactive transmission period, and a burst length of an active transmission period.

According to a seven aspect of the invention a method, comprises: defining at least one parameter of a control signal for an uplink control channel using a predetermined criterion, the at least one parameter depending on at least one of: a maximum allowed data rate of a data signal on an uplink data channel, and an actual data rate of the data signal; and receiving by a network element the control signal with the at least one parameter on the uplink control channel.

According further to the seventh aspect of the invention, the defining may be provided by the network element and the control signal may be provided by a user equipment.

Still further according to the seventh aspect of the invention, the control signal may be discontinuous and the at least one parameter may comprise at least one of: a preamble length of a preamble of the control signal, a gap length of inactive transmission period, and a burst length of an active transmission period.

According to an eighth aspect of the invention, a computer program product comprises: a computer readable storage structure embodying computer program code thereon for execution by a computer processor with the computer program code, wherein the computer program code comprises instructions for performing the seventh aspect of the invention, indicated as being performed by a component or a combination of components of a user equipment or a network element.

### BRIEF DESCRIPTION OF THE DRAWINGS

FIG. 1 is a diagram demonstrating definitions of a gap length, a burst length and a DTX pattern length;

FIG. 2 is a block diagram which demonstrates defining parameters of a control signal for an uplink (UL) dedicated physical control channel (DPCCH), according to embodiments of the present invention; and

FIG. 3 is a flow chart which demonstrates defining parameters for an uplink (UL) dedicated physical control channel (DPCCH), according to an embodiment of the present invention.

### MODES FOR CARRYING OUT THE INVENTION

A new method, system, apparatus and software product are presented for defining parameters for a control signal (e.g., discontinuous signal) for an uplink control channel (transmitted from a user equipment to a network element) using a predetermined criterion depending on a maximum allowed data rate and/or an actual data rate of a data signal on an uplink data channel. The parameters can comprise at least one of: a preamble length of a preamble of the control signal, a gap length of inactive transmission period and/or a burst length of an active transmission period of the discontinuous control signal. The uplink control channel can be an uplink (UL) dedicated physical control channel (DPCCH) and the data channel can be an enhanced dedicated channel (E-DCH).

According to embodiments of the present invention, the maximum allowed data rate can be provided to the user equipment (UE) by the network element (NE). Moreover, dependence of the parameter or parameters for the control signal on the maximum allowed data rate or on the actual data rate according to the predetermined criterion can be also provided to the UE by the network element or can be provided in a specification. For example, it could be at least one threshold value for the maximum allowed data rate or for the actual data rate below which at least one parameter (e.g., the preamble length or the gap length), defined according to the predetermined criterion, has a first value and above which the at least one parameter has a second value (the predetermined criterion can be provided by the network element or in the specification). Furthermore, defining the parameters for the control signal transmitted on the uplink control channel can be provided by the user equipment or alternatively by the network element.

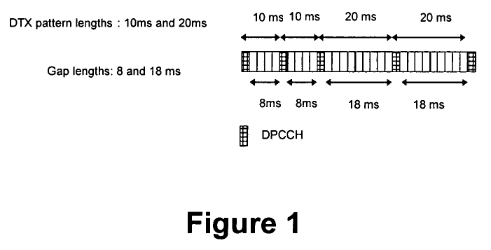

FIG. 1 shows the definitions for gap length, transmission burst length and DTX pattern length as examples, when it is assumed in this example that the duration of a DPCCH transmission (i.e., the burst length) is 2 ms during each DTX pattern length. First the DTX pattern length is 10 ms and after two periods, the DTX pattern length is doubled to 20 ms. When the DTX pattern length is 10 ms and the duration of DPCCH transmission is 2 ms, the gap length is 8 ms. When the DTX pattern length is 20 ms and the duration of DPCCH transmission burst is 2 ms, the gap length is 18 ms.

Thus, according to various embodiments of the present invention, the preamble length, the gap length and/or the burst length (defining the DPCCH transmission ON/OFF-ratio), e.g., for the DPCCH, could depend on the instantaneous E-DCH data rate and/or on the maximum allowed E-DCH data rate. The maximum allowed E-DCH data rate can be defined, for example, with a scheduled grant/assigned serving grant indicating which data rate is the maximum allowed for the UE, wherein “scheduled” refers to a maximum allowed data rate (the maximum allowed E-DPDCH/DPCCH power ratio (serving grant, SG), which is used in the E-DCH TFC selection) as scheduled by the Node B in the case of scheduled MAC-d flows and “assigned” refers to a maximum allowed data rate (a maximum number of bits that can be included in a MAC-e PDU for the given MAC-d flow) as assigned by the RNC (radio network controller) in the case of non-scheduled MAC-d flow.

Generally, more frequent DPCCH transmission should be facilitated for high maximum allowed data rates and/or actual data rates than for low maximum allowed data rates and/or actual data rates. This could be implemented, e.g., by:
using DPCCH pattern (e.g., gap length and DPCCH burst length) dependent on the actual E-DCH data rate or on the maximum allowed E-DCH data rate provided by the grant (e.g., using scheduling grant or non-scheduled grant): less DPCCH transmission (longer transmission burst duration and/or shorter gaps) for lower actual data rates or lower maximum allowed data rates (grants), and more DPCCH transmission (longer transmission duration and/or shorter gaps) for higher actual data rates or higher maximum allowed data rates (grants), and/or
using preamble length dependent on the actual E-DCH data rate or on the maximum allowed E-DCH data rate provided by the grant (e.g., using scheduling grant or non-scheduled grant).

As an example for the preamble dependence on the actual data rate, when the actual E-DCH data rate is high, a longer preamble can be used and when the actual E-DCH data rate is low, a shorter (or no) preamble can be used. The correspondence of the E-DCH data rate and the preamble length could be defined in the specification or signaled to the UE in the beginning of the call by the network. E.g., for each E-DCH data rate (if defined in specification, or using maximum allowed data rate if signaled), a preamble length could be defined. For example, the preamble length could be defined as follows: a) if data rate is less than x1 kbps, the preamble length is y1 slots (y1 could be also zero, i.e., no preamble), b) if the data rate is larger than x1 kbps but smaller than x2 kbps, the preamble length is y2 slots and c) if the data rate is larger than x2 kbps, the preamble length is y3 slots (x2 can also be equal to x1, i.e., only one data rate threshold for the preamble lengths usage can be used).

The preamble length can depend on the maximum allowed E-DCH data rate (scheduling grant signaled to the UE from the Node B or non-scheduled grant signaled to the UE from the RNC). When the maximum allowed E-DCH data rate is high, a longer preamble can be used and when the maximum allowed E-DCH data rate is low, a shorter (or no) preamble can be used. The correspondence of the maximum allowed E-DCH data rate and the preamble length could be defined in the specification or signaled to the UE at the beginning of the call. Thus, for each possible maximum allowed E-DCH data rate, a preamble length can be defined. For example, the preamble length could be defined as follows: a) if the maximum allowed E-DCH data rate is smaller than x1 kbps, the preamble length is y1 slots (y1 could also be zero, i.e., no preamble), b) if the maximum allowed E-DCH data rate is larger than x1 kbps but smaller than x2 kbps, the preamble length is y2 slots and c) if the maximum allowed E-DCH data rate is larger than x2 kbps, the preamble length is y3 slots (x2 could be also equal to x1, i.e., only maximum allowed E-DCH data rate threshold for the preamble lengths usage can be used).

Thus generally, according to embodiments of the present invention, there could be a threshold data rate or a threshold maximum allowed data rate at or below which the parameters could be set to one value and above which to another value. The threshold could only affect one of the parameters and it could be zero as well, i.e., if the UE is not allowed to transmit, it would use different parameterisation than if it is allowed to transmit.

Furthermore, the maximum allowed E-DCH data rate may be HARQ process specific in case of 2 ms E-DCH TTI. However, the UE and the serving Node B know the applied maximum allowed E-DCH data rate all the time (when the signaling errors are not taken into account). The non-serving Node B(s) could do DPCCH DTX (discontinuous transmission) detection and E-DPCCH detection continuously.

It is noted that the scheduler (e.g., a network element) can assign the UE with a maximum allowed relative power for the E-DPDCH which can be converted to the maximum allowed data rate internally in the UE by the E-TFC (E-DCH transport format combination) selection according to specified rules and signalled parameters. Thus the description of scheduling a data rate can take place by means of giving the UE a maximum E-DPDCH power relative to the DPCCH. Furthermore, the network element can assign the UE with a maximum number of bits that can be included in a MAC-e PDU for the given non-scheduled MAC-d flow which can be converted to the maximum allowed data rate internally in the UE by the E-TFC selection function according to specified rules and signalled parameters.

It is noted that all embodiments of the present invention described above for the control channel, e.g., the UL DPCCH, can be applied to any L1 control channel in the UL (carrying, e.g., pilot and/or power control information) used for, e.g., channel estimation and power control and for downlink control channels as well.

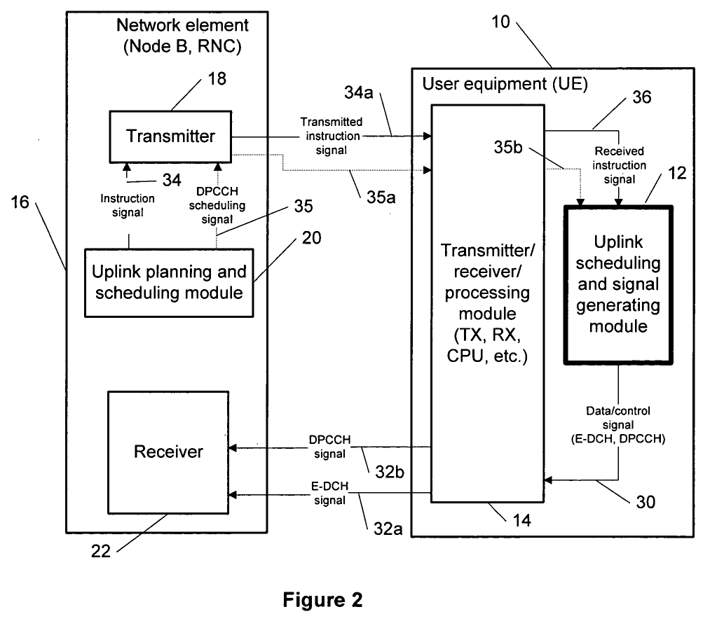

FIG. 2 shows a block diagram of an example among others which demonstrates defining parameters of a control signal for an uplink (UL) dedicated physical control channel (DPCCH), according to embodiments of the present invention.

In the example of FIG. 2, a user equipment 10 comprises an uplink scheduling and signal generating module 12 and a transmitter/receiver/processing module 14. Steps performed by the user equipment 10 related, e.g., to the discontinuous DPCCH transmission can be coordinated and originated by the module 12. The module 12 can be generally viewed as means for defining signal parameters or a structural equivalence (or an equivalent structure) thereof. Also, the module 14 can generally be transmitting and/or receiving means, e.g., a transceiver, or a structural equivalence (or equivalent structure) thereof. The user equipment 10 can be a wireless device, a portable device, a mobile communication device, a mobile phone, etc. In the example of FIG. 2, a network element 16 (e.g., a node B or a radio network controller, RNC) comprises a transmitter 18, an uplink planning and scheduling module 20 and a receiver 22.

According to an embodiment of the present invention, the module 12 (the same is applicable to the module 20 and 14) can be implemented as a software or a hardware module or a combination thereof. Furthermore, the module 12 (as well as 20 or 14) can be implemented as a separate block or can be combined with any other standard block of the user equipment 10 or it can be split into several blocks according to their functionality. The transmitter/receiver/processing block 14 can be implemented in a plurality of ways and typically can include a transmitter, a receiver and a CPU (central processing unit), etc. The transmitter and receiver can be combined, for example, in one module such as transceiver, as known in the art. The module 14 provides an effective communication of the module 12 with the network element 16 as described below in more detail. All or selected modules of the user equipment 10 can be implemented using an integrated circuit, and all or selected modules of the network element 16 can be implemented using an integrated circuit as well.

An instruction signal 34 (e.g., comprising the maximum allowed data rate, the maximum allowed relative power for the E-DPDCH or the maximum number of bits that can be included in a MAC-e PDU for the given MAC-d flow) from the block 20 is transmitted (see signal 34a) by the transmitter block 18 of the network element 16 to the transmitter/receiver/processing module 14 of the user equipment 10 and then forwarded (see signal 36) to the module uplink scheduling and signal generating module 12. The module 12 provides a data/control signal 30, generated according to embodiments of the present invention, which are then forwarded (signals 32a and 32b) to the receiver block 22 of the network element 16. Specifically, the module 12 provides a data signal (e.g., an E-DCH signal 32a) and a control signal (e.g., a discontinuous DPCCH signal 32b) and possibly having preamble, defined using the predetermined criterion, according to embodiments of the present invention presented herein.

FIG. 1 further demonstrates an optional embodiment wherein the scheduling of the DPCCH signal is performed by the network element 16 (e.g., by the block 20), using signals 35, 35a and 35b, e.g., provided by the NE instead of the signals 34, 34a and 36.

It is noted that the network element 16, for the purposes of understanding of various embodiments of the present invention, can be broadly interpreted such that the network element 16 can comprise features attributed to both the Node B and the radio network controller (RNC). Specifically, the module 20 can be located in the RNC (then the signaling from the RNC is forwarded to the user equipment by the Node B) or in the Node B, whereas the block 22 is located in the Node B.

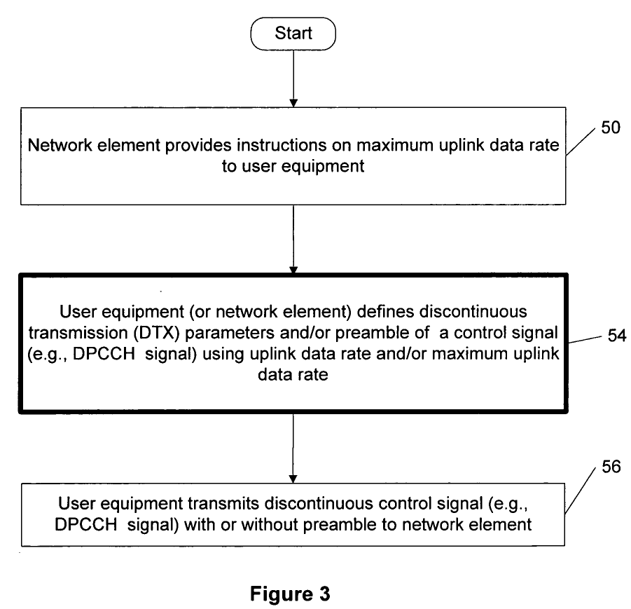

FIG. 3 is an example of a flow chart, which demonstrates defining parameters for an uplink (UL) dedicated physical control channel (e.g., DPCCH), according to an embodiment of the present invention.

The flow chart of FIG. 3 only represents one possible scenario among others. The order of steps shown in FIG. 3 is not absolutely required, so generally, the various steps can be performed out of order. In a method according to an embodiment of the present invention, in a first step 50 the network element 16 provides to the user equipment 10 instructions on the maximum uplink (DPCCH) data rate. In a next step 54, the user equipment 10 defines the discontinuous DPCCH transmission (DTX, gating) parameters and/or the preamble of the control signal using the uplink data rate and/or maximum uplink data rate of the uplink data signal (e.g., the E-DCH signal 32a). Finally, in a next step 56, the user equipment 10 transmits the control signal (e.g., the DPCCH signal 32b) with or without the preamble, as defined according to various embodiments described herein, to the network element 16.

As explained above, the invention provides both a method and corresponding equipment consisting of various modules providing the functionality for performing the steps of the method. The modules may be implemented as hardware, or may be implemented as software or firmware for execution by a computer processor. In particular, in the case of firmware or software, the invention can be provided as a computer program product including a computer readable storage structure embodying computer program code (i.e., the software or firmware) thereon for execution by the computer processor.

It is noted that various embodiments of the present invention recited herein can be used separately, combined or selectively combined for specific applications.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method, comprising:
defining at least one parameter of a control signal for an uplink control channel using a predetermined criterion, said at least one parameter depending on at least one of:
a maximum allowed data rate of a data signal on an uplink data channel, and
an actual data rate of said data signal; and
transmitting said control signal with said at least one parameter on said uplink control channel by a user equipment to a network element.

2. The method of claim 1, wherein said control signal is discontinuous and said at least one parameter comprises at least one of:
a preamble length of a preamble of said control signal,
a gap length of inactive transmission period, and
a burst length of an active transmission period.

3. The method of claim 1, wherein a dependence of said at least one parameter on said maximum allowed data rate or on said actual data rate according to said predetermined criterion is provided by the network element or provided in a specification.

4. The method of claim 1, wherein there is at least one threshold value for said maximum allowed data rate or for said actual data rate below which said at least one parameter, defined according to the predetermined criterion, has a first value and above which said at least one parameter has a second value.

5. The method of claim 1, wherein said network element is a Node B and said network element and said user equipment are configured for wireless communications.

6. The method of claim 1, wherein maximum allowed data rate is provided by said network element.

7. The method of claim 1, wherein said uplink control channel is an uplink dedicated physical control channel and said data channel is an enhanced dedicated channel.

8. The method of claim 7, wherein said maximum allowed data rate for said uplink dedicated physical control channel is determined by said user equipment using one of:
a maximum allowed relative power for an uplink dedicated physical control channel, said allowed relative power being provided by the network element to the user equipment, and
a maximum number of bits for a MAC-e protocol data unit for a given MAC-d flow.

9. The method of claim 1, wherein said defining is provided by said user equipment.

10. A computer program product comprising: a computer readable storage structure embodying computer program code thereon for execution by a computer processor with said computer program code, wherein said computer program code comprises instructions for performing the method of claim 1, indicated as being performed by a component or a combination of components of a user equipment or a network element.

11. A user equipment, comprising:
an uplink scheduling and signal generating module, configured to define at least one parameter of a control signal for an uplink control channel using a predetermined criterion, said at least one parameter depending on at least one of:
a maximum allowed data rate of a data signal on an uplink data channel, and
an actual data rate of said data signal; and
a receiving/transmitting/processing module, configured to transmit said control signal with said at least one parameter on said uplink control channel to a network element.

12. The user equipment of claim 11, wherein said control signal is discontinuous and said at least one parameter comprises at least one of:
a preamble length of a preamble of said control signal,
a gap length of inactive transmission period, and
a burst length of an active transmission period.

13. The user equipment of claim 11, wherein a dependence of said at least one parameter on said maximum allowed data rate or on said actual data rate according to said predetermined criterion is provided by the network element or provided in a specification.

14. The user equipment of claim 11, wherein there is at least one threshold value for said maximum allowed data rate or for said actual data rate below which said at least one parameter, defined according to the predetermined criterion, has a first value and above which said at least one parameter has a second value.

15. The user equipment of claim 11, wherein maximum allowed data rate is provided to said user equipment by said network element.

16. The user equipment of claim 11, wherein said uplink control channel is an uplink dedicated physical control channel and said data channel is an enhanced dedicated channel.

17. The user equipment of claim 16, wherein the uplink scheduling and signal generating module is configured to determine said maximum allowed data rate for said uplink dedicated physical control channel using one of:
a maximum allowed relative power for an uplink dedicated physical control channel, said allowed relative power being provided by the network element to the user equipment, and
a maximum number of bits for a MAC-e protocol data unit for a given MAC-d flow.

18. The user equipment of claim 11, wherein an integrated circuit comprises the uplink scheduling and signal generating module and the receiving/transmitting/processing module.

19. A user equipment, comprising:
means for defining at least one parameter of a control signal for an uplink control channel using a predetermined criterion, said at least one parameter depending on at least one of:
a maximum allowed data rate of a data signal on an uplink data channel, and
an actual data rate of said data signal; and
means for transmitting said control signal with said at least one parameter on said uplink control channel to a network element.

20. The user equipment of claim 19, wherein said at least one parameter comprises at least one of:
a preamble length of a preamble of said control signal,
a gap length of inactive transmission period, and
a burst length of an active transmission period.

21. A network element, comprising:
an uplink planning and scheduling module, configured to provide at least one of:
a maximum allowed data rate of a data signal on an uplink data channel, and
a maximum allowed relative power for an uplink dedicated physical control channel,
which are for defining at least one parameter of a control signal for an uplink control channel using a predetermined criterion; and
a receiver, configured to receive said control signal with said at least one parameter transmitted by a user equipment on said uplink control channel.

22. The network element of claim 21, wherein said defining of said at least one parameter is performed by the user equipment or by the network element.

23. The user equipment of claim 21, wherein said control signal is discontinuous and said at least one parameter comprises at least one of:
a preamble length of a preamble of said control signal,
a gap length of inactive transmission period, and
a burst length of an active transmission period.

24. A communication system, comprising:
a user equipment, configured to provide a data signal on an uplink data channel and a control signal on an uplink control channel, wherein at least one parameter of the control signal is defined by a predetermined criterion using at least one of:
a maximum allowed data rate of a data signal on an uplink data channel, and
an actual data rate of said data signal; control channel;
and a network element, configured to receive said control signal with said at least one parameter.

25. The system of claim 24, wherein said network element is a Node B and said network element and said user equipment are configured for wireless communications.

26. The system of claim 24, wherein said defining is provided by said network element or by said user equipment.

27. The system of claim 24, wherein said control signal is discontinuous and said at least one parameter comprises at least one of:
a preamble length of a preamble of said control signal,
a gap length of inactive transmission period, and
a burst length of an active transmission period.

28. A method, comprising:
defining at least one parameter of a control signal for an uplink control channel using a predetermined criterion, said at least one parameter depending on at least one of:
a maximum allowed data rate of a data signal on an uplink data channel, and
an actual data rate of said data signal; and
receiving by a network element said control signal with said at least one parameter on said uplink control channel.

29. The method of claim 28, wherein said defining is provided by said network element and said control signal is provided by a user equipment.

30. The method of claim 28, wherein said control signal is discontinuous and said at least one parameter comprise at least one of:
a preamble length of a preamble of said control signal,
a gap length of inactive transmission period, and
a burst length of an active transmission period.

31. A computer program product comprising: a computer readable storage structure embodying computer program code thereon for execution by a computer processor with said computer program code, wherein said computer program code comprises instructions for performing the method of claim 28, indicated as being performed by a component or a combination of components of a user equipment or a network element.
